(19) United States
(12) Patent Application Publication
(10) Pub. No.: US 2020/0159372 A1
(43) Pub. Date: May 21, 2020

(54) PINNED BAR APPARATUS AND METHODS

(71) Applicant: General Electric Company, Schenectady, NY (US)

(72) Inventors: Keith Bates, Pittsburgh, PA (US); Megan Pastore, Pittsburgh, PA (US)

(21) Appl. No.: 16/198,364

(22) Filed: Nov. 21, 2018

(51) Int. Cl. G06F 3/0482; G06F 9/451; G06F 3/0481; G06F 3/0486

(52) U.S. Cl. CPC G06F 3/0482; G06F 9/451; G06F 2203/04803; G06F 3/0486; G06F 3/04817

(57) ABSTRACT

Systems, methods, and apparatus providing a user interface to display clinical data and a clinical worklist are disclosed and described. An example system includes a memory to store instructions, data, and configuration information; and a processor to execute the instructions to generate a user interface. The example user interface includes at least a worklist area to display indicators associated with items to be opened for review, the items selectable to be opened or moved, the worklist area to be hidden or displayed based on a configuration of the user interface. The example user interface also includes a pinned area to display a copy of a selected subset of the items in the worklist area, the pinned area to remain visible when the worklist area is hidden and to persist across sessions of the user interface, wherein a data structure associated with the subset of the items is to be flagged.

### FIELD OF DISCLOSURE

The present disclosure relates to user interfaces, and more particularly to systems, methods and computer program products to generate a user interface including a worklist area and a pinned area.

### BACKGROUND

The statements in this section merely provide background information related to the disclosure and may not constitute prior art.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored can include patient medication orders, medical histories, imaging data, test results, diagnosis information, management information, and/or scheduling information, for example. A wealth of information is available, but the information can be siloed in various separate systems requiring separate access, search, and retrieval. Correlations between healthcare data remain elusive due to technological limitations on the associated systems.

Further, when data is brought together for display, the amount of data can be overwhelming and confusing. Such data overload presents difficulties when trying to display, and competing priorities put a premium in available screen real estate. Existing solutions are deficient in addressing these and other related concerns.

### BRIEF DESCRIPTION

Certain examples provide a graphical user interface system to display clinical data and a clinical worklist. The example system includes a memory to store instructions, data, and configuration information; and a processor to execute the instructions to generate a user interface. The example user interface includes at least a worklist area to display indicators associated with items to be opened for review, the items selectable to be opened or moved, the worklist area to be hidden or displayed based on a configuration of the user interface. The example user interface also includes a pinned area to display a copy of a selected subset of the items in the worklist area, the pinned area to remain visible when the worklist area is hidden and to persist across sessions of the user interface, wherein a data structure associated with the subset of the items is to be flagged.

Certain examples provide a computer-readable storage medium including instructions which, when executed, cause at least one processor to generate a user interface. The example user interface includes at least a worklist area to display indicators associated with items to be opened for review, the items selectable to be opened or moved, the worklist area to be hidden or displayed based on a configuration of the user interface. The example user interface also includes a pinned area to display a copy of a selected subset of the items in the worklist area, the pinned area to remain visible when the worklist area is hidden and to persist across sessions of the user interface, wherein a data structure associated with the subset of the items is to be flagged.

Certain examples provide a computer-implemented method including: displaying, in a worklist area of a user interface, indicators associated with items to be opened for review, the items including a first item selectable to be opened and moved; displaying, in response to selecting a first indicator associated with the first item in the worklist area, a copy of the first item in a pinned area of the user interface; flagging, in response to selecting the first indicator in the worklist area, a data structure associated with the first item; hiding, in response to at least one of an interaction or a user interface configuration, the worklist area on the user interface; and persisting display of the pinned area when the worklist area is hidden.

### BRIEF DESCRIPTION OF THE DRAWINGS

The features and technical aspects of the system and method disclosed herein will become apparent in the following Detailed Description in conjunction with the drawings in which reference numerals indicate identical or functionally similar elements.

FIG. 1 illustrates an example interface including a pinned area, a worklist, and a workspace.

FIG. 2 shows a block diagram of an example healthcare-focused information system.

FIG. 3 shows a block diagram of an example healthcare information infrastructure including one or more systems.

FIG. 4 shows an example industrial internet configuration including a plurality of health-focused systems.

FIG. 5 shows an example image desktop system.

FIG. 6 illustrates an example interface generation and interaction system.

FIGS. 7-10C illustrate flow diagrams for example method of user interface management.

FIGS. 11-12 illustrate example implementations of the interface of FIG. 1.

FIG. 13 shows a block diagram of an example processor system that can be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings. The figures are not scale. Wherever possible, the same reference numbers will be used throughout the drawings and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

In addition, it should be understood that references to “one embodiment” or “an embodiment” of the present disclosure are not intended to be interpreted as excluding the existence of additional embodiments that also incorporate the recited features.

### I. Overview

Aspects disclosed and described herein enable a healthcare (e.g., radiology, other clinician, etc.) desktop facilitating a healthcare workflow. An example healthcare desktop provides an interaction framework in which a worklist is integrated with a diagnostic space and can be manipulated into and out of the diagnostic space to progress from a daily worklist to a particular diagnosis/diagnostic view for a patient (and back to the daily worklist). The worklist infrastructure shows the clinician what is to be done and on what task(s) the he or she is current working. Data preference and relevancy can be determined with respect to a radiology workflow and/or radiology desktop application interface, for example. In certain examples, the radiology desktop provides a diagnostic hub and facilitates a dynamic workflow and adaptive composition of a graphical user interface.

In certain examples, the healthcare desktop provides a diagnostic hub and facilitates a dynamic workflow and adaptive composition of a graphical user interface. For example, the desktop graphical user interface provides an intelligently adaptive, dynamically adjustable interface based on information, not just user clicks, as well as dynamic real time updates from a server. The healthcare desktop provides a higher level framework built with multiple roles in mind (e.g., not only radiology but other -ologies as well to unify workflows and provide an expandable and reusable framework). Additionally, areas of the healthcare desktop interact such that an action on one client and triggers notification of another client regarding state change(s) corresponding to the action.

In an example, one side (e.g., a left hand side) of the healthcare desktop interface is configurable by the user. The user can select a worklist on the left side of the desktop graphical user interface (GUI), and the worklist appears (e.g., “pops out” or is otherwise displayed) on the side of the healthcare desktop GUI. The worklist and/or set of displayed information can be configured in a plurality of ways including via a segmented or tiered display area including a worklist, a subset of the worklist, and a workspace work area for document display and interaction, for example.

Aspects disclosed and described herein enable information aggregation and information filtering that cannot be accomplished in a current clinical workflow. In certain examples, a pinned bar or user interface segment can be formed adjacent to a worklist and/or other item bar or user interface segment to highlight and/or persist a certain portion of the worklist through changes to the worklist and/or other parts of the graphical user interface display. Thus, certain examples provide new functionality to the graphical user interface to enable dynamic pinning of items to a pinned bar, tracking of pinned items across sessions or instances of the interface, and facilitating dynamic unpinning or removal of items from the pinned bar as well.

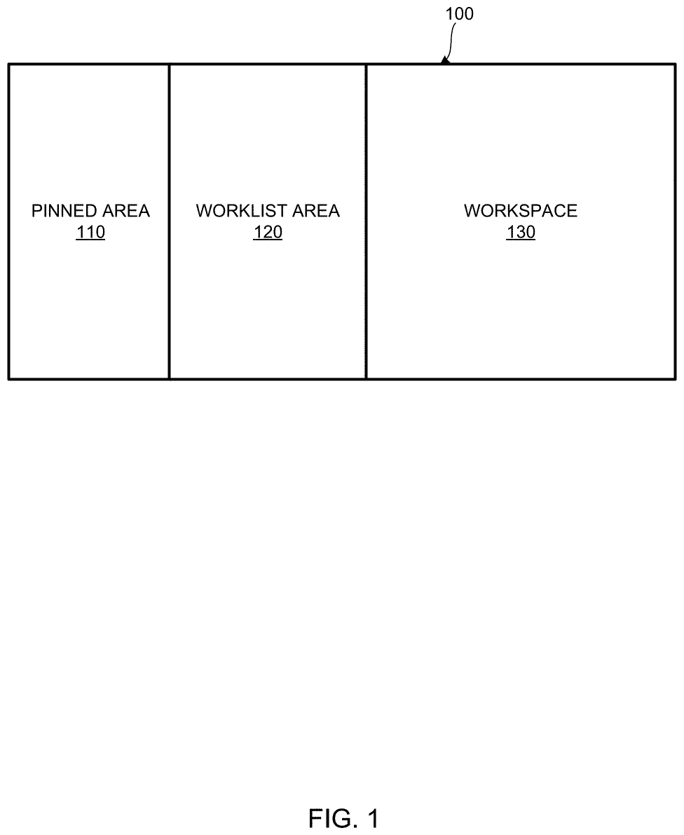

For example, FIG. 1 illustrates an example interface 100 including a pinned area 110, a worklist area 120, and a workspace 130 (e.g., a diagnostic hub, work area, etc.). Items in the worklist area 120 include patient exams to be obtained, reviewed, referred, etc. A program and/or user can select items from the worklist area 120 to be held, made static on the display, or “pinned” to the pinned area 110. Thus, an item (e.g., an exam tile, indicator, record, etc.) can be present in both the worklist area 120 and the pinned area 110, but, typically, all items in the worklist area 120 are pinned in the pinned area 110. Rather, items requiring further attention, items of high importance, items representing shortcuts (e.g., all unread exams, all recent exams, etc.) are pinned and/or otherwise selected for the pinned area 110. Selection of the item in the pinned area 110 or the worklist area 120 opens that item in the workspace 130 for further user action (e.g., exam reading, exam recording, image annotation, labs review, referral, orders, etc.). While the worklist area 120 can be hidden or removed from the interface screen 100, the pinned area 110 and its contents are maintained on the interface 100 and can be selected.

In certain examples, items in the pinned area 110 can be reordered by dragging and dropping them in the pinned area 110. An item can be dragged onto the pinned area 110 from the worklist area 120 and/or workspace 130 to add the item to the pinned area 110. An item can be dragged out of the pinned area 110 to remove the item from the pinned area 110. An item can also be selected in the worklist area 120 to add the item to the pinned area 110 (e.g., by checking a box, clicking on a pin and/or other icon, clicking on the item itself, etc.). The item can then be deselected from the worklist area 120 and/or the pinned area 110 to remove that item from the pinned area 110.

In certain examples, each item in the worklist area 120 and pinned area 110 is associated with a record in a data structure (e.g., a database, other data store, memory table, electronic medical record, etc.). When an item is pinned to the pinned area 110, a flag is set for that item's record in the data structure to indicate that the item is to be displayed in the pinned area 110.

In certain examples, the flag for the pinned item has other effects beyond the display. For example, database queries may act differently on items that are flagged versus items that are unflagged. Counts may be updated differently (e.g., more frequently, etc.) for flagged exams versus unflagged exams to save processing cycles, reduce information overload fatigue/distraction, etc. Exam records flagged as pinned may be updated every 15 seconds while unflagged exam records are updated every 30 seconds to improve performance, for example.

Other aspects, such as those discussed in the following and others as can be appreciated by one having ordinary skill in the art upon reading the enclosed description, are also possible.

### II. Example Operating Environment

Health information, also referred to as healthcare information and/or healthcare data, relates to information generated and/or used by a healthcare entity. Health information can be information associated with health of one or more patients, for example. Health information can include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure can include a centralized capability including, for example, a data repository, reporting, discreet data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. The example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

### a. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

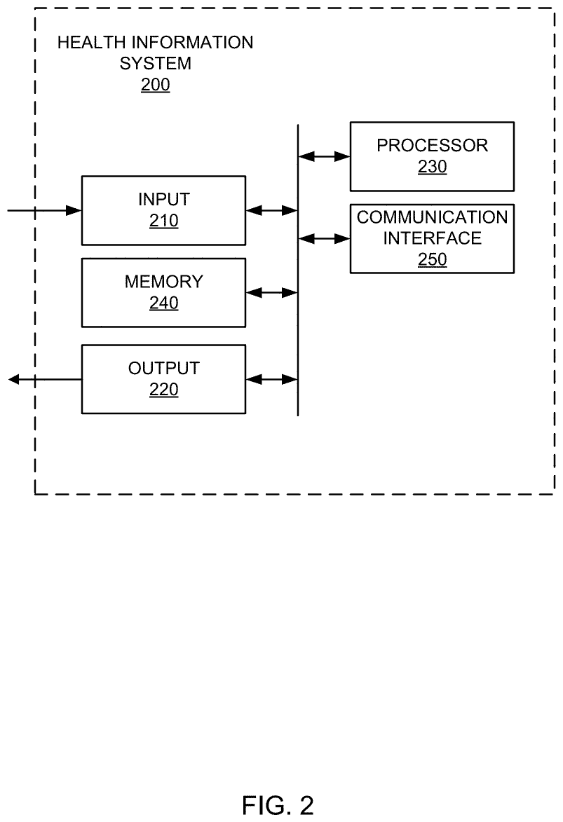

Turning now to the figures, FIG. 2 shows a block diagram of an example healthcare-focused information system 20. The example system 200 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 2, the example information system 200 includes an input 210, an output 220, a processor 230, a memory 240, and a communication interface 250. The components of the example system 200 can be integrated in one device or distributed over two or more devices.

The example input 210 can include a keyboard, a touch-screen, a mouse, a trackball, a track pad, optical barcode recognition, voice command, etc. or combination thereof used to communicate an instruction or data to the system 200. The example input 210 can include an interface between systems, between user(s) and the system 200, etc.

The example output 220 can provide a display generated by the processor 230 for visual illustration on a monitor or the like. The display can be in the form of a network interface or graphic user interface (GUI) to exchange data, instructions, or illustrations on a computing device via the communication interface 250, for example. The example output 220 can include a monitor (e.g., liquid crystal display (LCD), plasma display, cathode ray tube (CRT), etc.), light emitting diodes (LEDs), a touch-screen, a printer, a speaker, or other conventional display device or combination thereof.

The example processor 230 includes hardware and/or software configuring the hardware to execute one or more tasks and/or implement a particular system configuration. The example processor 230 processes data received at the input 210 and generates a result that can be provided to one or more of the output 220, memory 240, and communication interface 250. For example, the example processor 230 can take user annotation provided via the input 210 with respect to an image displayed via the output 220 and can generate a report associated with the image based on the annotation. For example, the output 220 can include the user interface 100 including the pinned area 110, worklist area 120, and workspace 130. As another example, the processor 230 can process updated patient information obtained via the input 210 to provide an updated patient record to an EMR via the communication interface 250.

The example memory 240 can include a relational database, an object-oriented database, a data dictionary, a clinical data repository, a data warehouse, a data mart, a vendor neutral archive, an enterprise archive, etc. The example memory 240 stores images, patient data, best practices, clinical knowledge, analytics, reports, etc. The example memory 240 can store data and/or instructions for access by the processor 230. In certain examples, the memory 240 can be accessible by an external system via the communication interface 250.

In certain examples, the memory 240 stores and controls access to encrypted information, such as patient records, encrypted update-transactions for patient medical records, including usage history, etc. In an example, medical records can be stored without using logic structures specific to medical records. In such a manner the memory 240 is not searchable. For example, a patient's data can be encrypted with a unique patient-owned key at the source of the data. The data is then uploaded to the memory 240. The memory 240 does not process or store unencrypted data thus minimizing privacy concerns. The patient's data can be downloaded and decrypted locally with the encryption key.

For example, the memory 240 can be structured according to provider, patient, patient/provider association, and document. Provider information can include, for example, an identifier, a name, and address, a public key, and one or more security categories. Patient information can include, for example, an identifier, a password hash, and an encrypted email address. Patient/provider association information can include a provider identifier, a patient identifier, an encrypted key, and one or more override security categories. Document information can include an identifier, a patient identifier, a clinic identifier, a security category, and encrypted data, for example. Patient records can include a flag stored in a data structure in the memory 240 to indicate whether or not that record is pinned in the pinned area 110, for example.

The example communication interface 250 facilitates transmission of electronic data within and/or among one or more systems. Communication via the communication interface 250 can be implemented using one or more protocols. In some examples, communication via the communication interface 250 occurs according to one or more standards (e.g., Digital Imaging and Communications in Medicine (DICOM), Health Level Seven (HL7), ANSI X12N, etc.). The example communication interface 250 can be a wired interface (e.g., a data bus, a Universal Serial Bus (USB) connection, etc.) and/or a wireless interface (e.g., radio frequency, infrared, near field communication (NFC), etc.). For example, the communication interface 250 can communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

### b. Example Healthcare Infrastructure

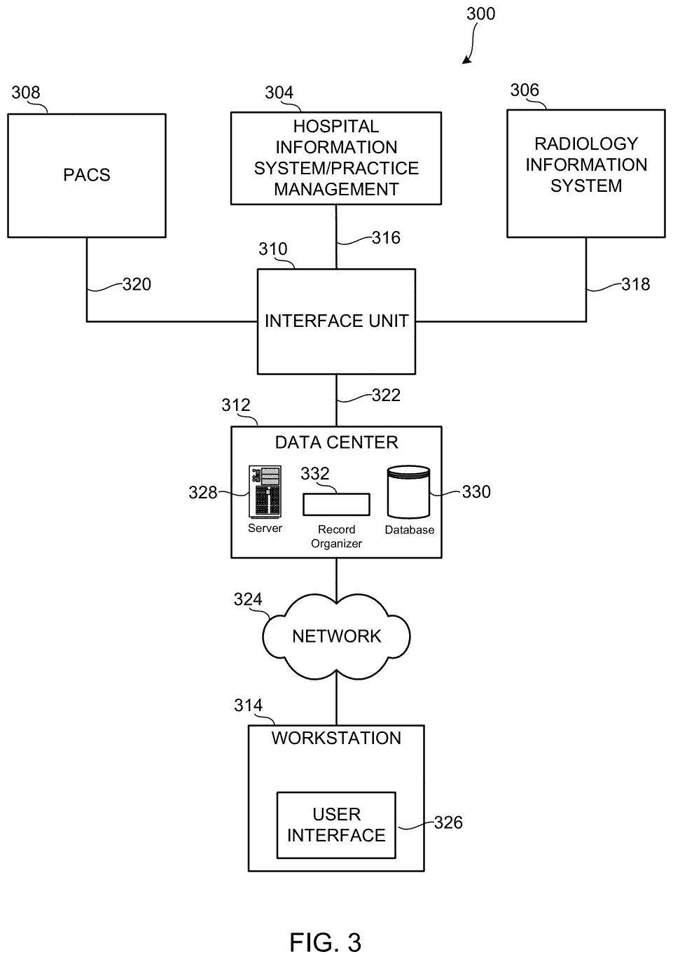

FIG. 3 shows a block diagram of an example healthcare information infrastructure 300 including one or more subsystems such as the example healthcare-related information system 200 illustrated in FIG. 2. The example healthcare system 300 includes a HIS 304, a RIS 306, a PACS 308, an interface unit 310, a data center 312, and a workstation 314. In the illustrated example, the HIS 304, the RIS 306, and the PACS 308 are housed in a healthcare facility and locally archived. However, in other implementations, the HIS 304, the MS 306, and/or the PACS 308 can be housed one or more other suitable locations. In certain implementations, one or more of the PACS 308, MS 306, HIS 304, etc., can be implemented remotely via a thin client and/or downloadable software solution. Furthermore, one or more components of the healthcare system 300 can be combined and/or implemented together. For example, the MS 306 and/or the PACS 308 can be integrated with the HIS 304; the PACS 308 can be integrated with the MS 306; and/or the three example information systems 304, 306, and/or 308 can be integrated together. In other example implementations, the healthcare system 300 includes a subset of the illustrated information systems 304, 306, and/or 308. For example, the healthcare system 300 can include only one or two of the HIS 304, the RIS 306, and/or the PACS 308. Information (e.g., scheduling, test results, exam image data, observations, diagnosis, etc.) can be entered into the HIS 304, the RIS 306, and/or the PACS 308 by healthcare practitioners (e.g., radiologists, physicians, and/or technicians) and/or administrators before and/or after patient examination.

The HIS 304 stores medical information such as clinical reports, patient information, and/or administrative information received from, for example, personnel at a hospital, clinic, and/or a physician's office (e.g., an EMR, EHR, PHR, etc.). The MS 306 stores information such as, for example, radiology reports, radiology exam image data, messages, warnings, alerts, patient scheduling information, patient demographic data, patient tracking information, and/or physician and patient status monitors. Additionally, the MS 306 enables exam order entry (e.g., ordering an x-ray of a patient) and image and film tracking (e.g., tracking identities of one or more people that have checked out a film). In some examples, information in the MS 306 is formatted according to the HL-7 (Health Level Seven) clinical communication protocol. In certain examples, a medical exam distributor is located in the MS 306 to facilitate distribution of radiology exams to a radiologist workload for review and management of the exam distribution by, for example, an administrator.

The PACS 308 stores medical images (e.g., x-rays, scans, three-dimensional renderings, etc.) as, for example, digital images in a database or registry. In some examples, the medical images are stored in the PACS 308 using the Digital Imaging and Communications in Medicine (DICOM) format. Images are stored in the PACS 308 by healthcare practitioners (e.g., imaging technicians, physicians, radiologists) after a medical imaging of a patient and/or are automatically transmitted from medical imaging devices to the PACS 308 for storage. In some examples, the PACS 308 can also include a display device and/or viewing workstation to enable a healthcare practitioner or provider to communicate with the PACS 308.

The interface unit 310 includes a hospital information system interface connection 316, a radiology information system interface connection 318, a PACS interface connection 320, and a data center interface connection 322. The interface unit 310 facilities communication among the HIS 304, the RIS 306, the PACS 308, and/or the data center 312. The interface connections 316, 318, 320, and 322 can be implemented by, for example, a Wide Area Network (WAN) such as a private network or the Internet. Accordingly, the interface unit 310 includes one or more communication components such as, for example, an Ethernet device, an asynchronous transfer mode (ATM) device, an 802.11 device, a DSL modem, a cable modem, a cellular modem, etc. In turn, the data center 312 communicates with the workstation 314, via a network 324, implemented at a plurality of locations (e.g., a hospital, clinic, doctor's office, other medical office, or terminal, etc.). The network 324 is implemented by, for example, the Internet, an intranet, a private network, a wired or wireless Local Area Network, and/or a wired or wireless Wide Area Network. In some examples, the interface unit 310 also includes a broker (e.g., a Mitra Imaging's PACS Broker) to allow medical information and medical images to be transmitted together and stored together.

The interface unit 310 receives images, medical reports, administrative information, exam workload distribution information, and/or other clinical information from the information systems 304, 306, 308 via the interface connections 316, 318, 320. If necessary (e.g., when different formats of the received information are incompatible), the interface unit 310 translates or reformats (e.g., into Structured Query Language (“SQL”) or standard text) the medical information, such as medical reports, to be properly stored at the data center 312. The reformatted medical information can be transmitted using a transmission protocol to enable different medical information to share common identification elements, such as a patient name or social security number. Next, the interface unit 310 transmits the medical information to the data center 312 via the data center interface connection 322. Finally, medical information is stored in the data center 312 in, for example, the DICOM format, which enables medical images and corresponding medical information to be transmitted and stored together.

The medical information is later viewable and easily retrievable at the workstation 314 (e.g., by their common identification element, such as a patient name or record number). The workstation 314 can be any equipment (e.g., a personal computer) capable of executing software that permits electronic data (e.g., medical reports) and/or electronic medical images (e.g., x-rays, ultrasounds, MM scans, etc.) to be acquired, stored, or transmitted for viewing and operation. The workstation 314 receives commands and/or other input from a user via, for example, a keyboard, mouse, track ball, microphone, etc. The workstation 314 is capable of implementing a user interface 326 to enable a healthcare practitioner and/or administrator to interact with the healthcare system 300. For example, in response to a request from a physician, the user interface 326 presents a patient medical history. In other examples, a radiologist is able to retrieve and manage a workload of exams (e.g., the worklist area 120) distributed for review to the radiologist via the user interface 326. For example, the user interface 326 can form the interface 100 including the pinned area 110, worklist area 120, and workspace 130. In further examples, an administrator reviews radiologist workloads, exam allocation, and/or operational statistics associated with the distribution of exams via the user interface 326. In some examples, the administrator adjusts one or more settings or outcomes via the user interface 326.

The example data center 312 of FIG. 3 is an archive to store information such as images, data, medical reports, and/or, more generally, patient medical records. In addition, the data center 312 can also serve as a central conduit to information located at other sources such as, for example, local archives, hospital information systems/radiology information systems (e.g., the HIS 304 and/or the RIS 306), or medical imaging/storage systems (e.g., the PACS 308 and/or connected imaging modalities). That is, the data center 312 can store links or indicators (e.g., identification numbers, patient names, or record numbers) to information. In the illustrated example, the data center 312 is managed by an application server provider (ASP) and is located in a centralized location that can be accessed by a plurality of systems and facilities (e.g., hospitals, clinics, doctor's offices, other medical offices, and/or terminals). In some examples, the data center 312 can be spatially distant from the HIS 304, the MS 306, and/or the PACS 308 (e.g., at GENERAL ELECTRIC® headquarters).

The example data center 312 of FIG. 3 includes a server 328, a database 330, and a record organizer 332. The server 328 receives, processes, and conveys information to and from the components of the healthcare system 300. The database 330 stores the medical information described herein and provides access thereto. The example record organizer 332 of FIG. 3 manages patient medical histories, for example. The record organizer 332 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by the system 300 via a software-as-a-service (SaaS) implementation over a cloud or other computer network, for example. In certain examples, all or part of the system 300 can also be provided via platform as a service (PaaS), infrastructure as a service (IaaS), etc. For example, the system 300 can be implemented as a cloud-delivered Mobile Computing Integration Platform as a Service. A set of consumer-facing Web-based, mobile, and/or other applications enable users to interact with the PaaS, for example.

### c. Industrial Internet Examples

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, provide a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

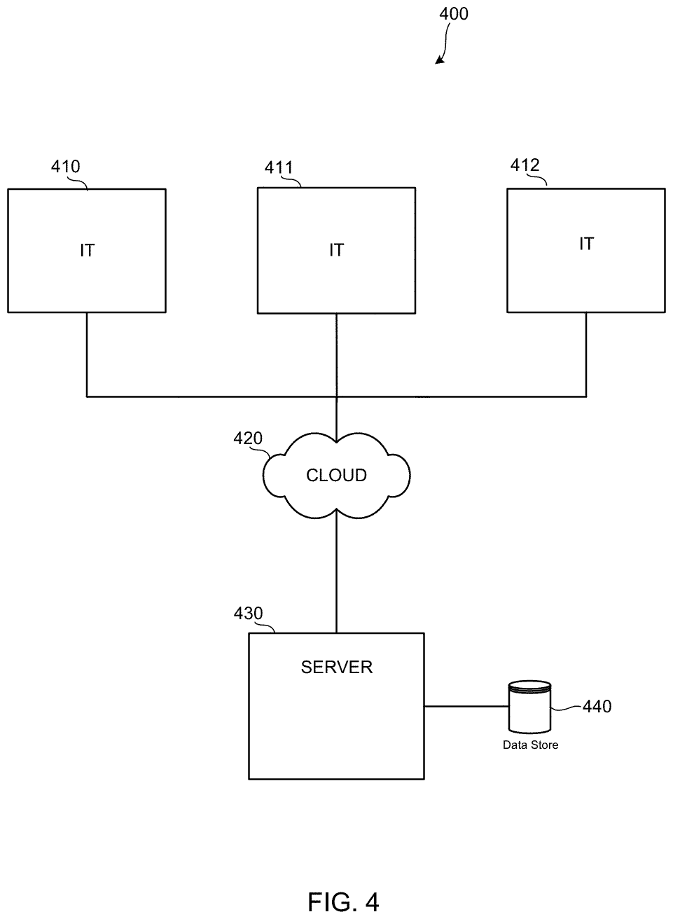

FIG. 4 illustrates an example industrial internet configuration 400. The example configuration 400 includes a plurality of health-focused systems 410-412, such as a plurality of health information systems 200 (e.g., PACS, RIS, EMR, etc.) communicating via the industrial internet infrastructure 400. The example industrial internet 400 includes a plurality of health-related information systems 410-412 communicating via a cloud 420 with a server 430 and associated data store 440.

As shown in the example of FIG. 4, a plurality of devices (e.g., information systems, imaging modalities, etc.) 410-412 can access a cloud 420, which connects the devices 410-412 with a server 430 and associated data store 440. Information systems, for example, include communication interfaces to exchange information with server 430 and data store 440 via the cloud 420. Other devices, such as medical imaging scanners, patient monitors, etc., can be outfitted with sensors and communication interfaces to enable them to communicate with each other and with the server 430 via the cloud 420.

Thus, machines 410-412 in the system 400 become “intelligent” as a network with advanced sensors, controls, and software applications. Using such an infrastructure, advanced analytics can be provided to associated data. The analytics combines physics-based analytics, predictive algorithms, automation, and deep domain expertise. Via the cloud 420, devices 410-412 and associated people can be connected to support more intelligent design, operations, maintenance, and higher server quality and safety, for example.

Using the industrial internet infrastructure, for example, a proprietary machine data stream can be extracted from a device 410. Machine-based algorithms and data analysis are applied to the extracted data. Data visualization can be remote, centralized, etc. Data is then shared with authorized users, and any gathered and/or gleaned intelligence is fed back into the machines 410-412.

### d. Imaging Workstation Examples

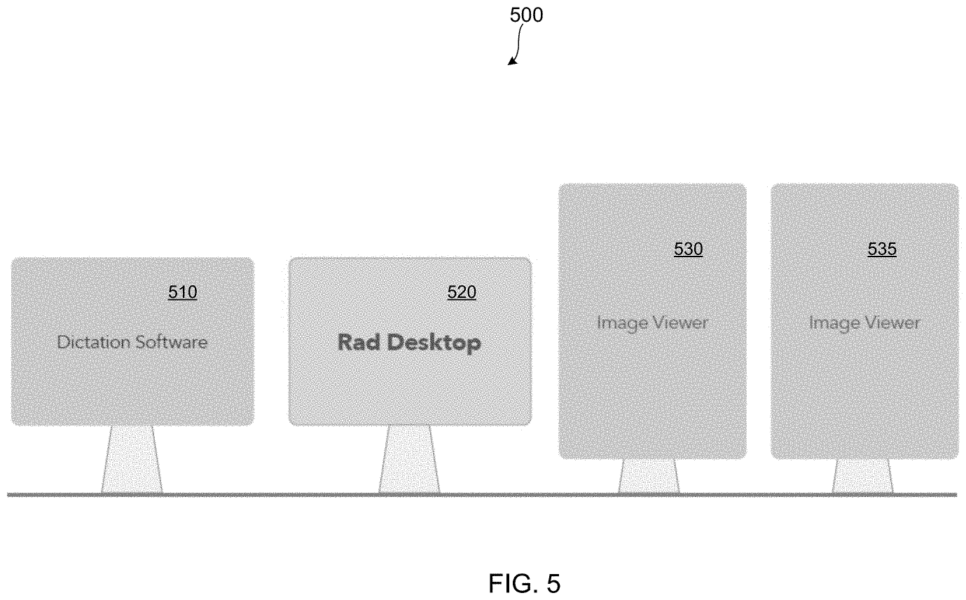

FIG. 5 illustrates an example imaging desktop system including an image/exam viewer implemented on a plurality of diagnostic monitors 530, 535. A dictation application 510 either sits side-by-side with a radiology desktop or workflow manager 520, on a same monitor as the radiology desktop/workflow manager 520, or behind/in front of the radiology desktop/workflow manager 520 such that a user toggles between two windows 510, 520. In other examples, image viewing, image analysis, and/or dictation can be combined on a single workstation. Thus, the multiple displays 510-535 can be combined into a single interface (e.g., the example interface 100, 326) having a plurality of windows or areas for information display and interaction.

A radiologist, for example, can be presented with summary information, trending, and extracted features made available so that the radiology does not have to search through a patient's prior radiology report history. The radiologist receives decision support including relevant clinical and diagnostic information to assist in a more definitive, efficient diagnosis.

In certain examples, a current study on the worklist area 120 for one or more patients X, Y, Z is prefetched from a data source. If a current study for patient X is being processed (e.g., selected from the pinned area 110 or worklist area 120 for review in the workspace 130, etc.), prior report(s) for patient X are located (e.g., from a picture archiving and communication system (PACS), enterprise archive (EA), radiology information system (RIS), electronic medical record (EMR), etc.). For example, report text and prior study metadata including a reason for exam, exam code, study, name, location, etc., are provided from a PACS as prior data for mining, extraction, and processing via the workspace 130.

In certain examples, a workload manager resides on a side (e.g., a left-hand side, a right-hand side, top, bottom, etc.) of a radiology desktop and can be opened or otherwise accessed to access exams. The worklist area 120 and pinned area 110 can be associated with and/or included in the workload manager. When an exam access is not desired, the worklist area 120 workload manager can be closed or hidden with respect to the radiology desktop (e.g., with respect to a diagnostic hub on the radiology desktop). However, the pinned area 110 of the workload manager remains visible and accessible via the user interface 100. The workload manager and/or an associated diagnostic hub can leverage the information identification, retrieval, and relevancy determination systems and methods disclosed and described herein to provide information for research, comparison, supplementation, guidance, etc., in conjunction with an exam under review (e.g., via an exam preview panel from a patient library, etc.).

For example, the diagnostic hub can include a patient banner. The patient banner displays patient demographic data as well as other patient information that is persistent and true regardless of the specific exam (e.g., age, medical record number (MRN), cumulative radiation dose, etc.). The diagnostic hub also includes a primary exam preview panel. The primary exam preview panel provides a summary of the exam that the radiologist is currently responsible for reading (e.g., the exam that was selected from an active worklist). Exam description and reason for exam can be displayed to identify the exam, followed by metadata such as exam time, location, referrer, technologist, etc.

A patient library is devoted to helping a radiologist focus on relevant comparison exams, as well as any additional clinical content to aid in diagnosis. The patient library of the diagnostic hub can include subsections such as a clinical journey, comparison list, a comparison exam preview panel, etc. The clinical journey is a full patient ‘timeline’ of imaging exams, as well as other clinical data such as surgical and pathology reports, labs, medications, etc. The longitudinal view of the clinical journey helps the radiologist notice broader clinical patterns more quickly, as well as understand a patient's broader context that may not be immediately evident in a provided reason for the primary exam. Tools can be provided to navigate within the clinical journey. A user can adjust a time frame, filter for specific criteria, turn relevancy on or off, add or remove content categories, etc. The clinical journey also integrates with the comparison list. Modifying filter or search criteria in the clinical journey can impact the exams displayed on the comparison list.

The comparison list provides one or more available comparison exams for the current patient/primary exam. The comparison list provides a quick access point for selecting comparisons, as opposed to the more longitudinal clinical journey. Display can be limited to only show relevant exams based on the relevancy algorithm, for example. The comparison exam preview panel is similar to the primary exam preview panel, with alterations in content display to account for a radiologist's shift in priorities when looking at a comparison (e.g., selected from the comparison list, etc.). Rather than providing a reason for exam, a history and impression from the exam's report are displayed (or the whole report, if extraction is not possible or desired, etc.).

### e. Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. For example, exam records can be indexed according to whether or not the records are flagged as pinned for display in the pinned area 110 and/or otherwise designated as important. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves.

### f. Example Clinical Workflows

Clinical workflows are typically defined to include one or more steps, elements, and/or actions to be taken in response to one or more events and/or according to a schedule. Events may include receiving a healthcare message associated with one or more aspects of a clinical record, opening a record(s) for new patient(s), receiving a transferred patient, reviewing and reporting on an image, and/or any other instance and/or situation that requires or dictates responsive action or processing. The actions, elements, and/or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, and/or any other action useful in processing healthcare information. The defined clinical workflows can include manual actions, elements, and/or steps to be taken by, for example, an administrator or practitioner, electronic actions, elements, and/or steps to be taken by a system or device, and/or a combination of manual and electronic action(s), element(s), and/or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc.

For example, a radiology department in a hospital, clinic, or other healthcare facility facilitates a sequence of events for patient care of a plurality of patients. At registration and scheduling, a variety of information is gathered such as patient demographic, insurance information, etc. The patient can be registered for a radiology procedure, and the procedure can be scheduled on an imaging modality.

Before the patient arrives for the scheduled procedures, pre-imaging activities can be coordinated. For example, the patient can be advised on pre-procedure dietary restrictions, etc. Upon arrive, the patient is checked-in, and patient information is verified. Identification, such as a patient identification tag, etc., is issued.

Then, the patient is prepared for imaging. For example, a nurse or technologist can explain the imaging procedure, etc. For contrast media imaging, the patient is prepared with contrast media etc. The patient is guided through the imaging procedure, and image quality is verified. Using an image viewer and reporting tools, the radiologist reads the resulting image(s), performs dictation in association with the images, and approves associated reports. For example, the radiologist activates the interface 100, selects the patient's exam from the pinned area 110 or the worklist area 120 to open the exam record in the workspace 130 and read and report on the exam. A billing specialist can prepare a claim for each completed procedure, and claims can be submitted to an insurer.

### III. Example Pinned Bar Apparatus

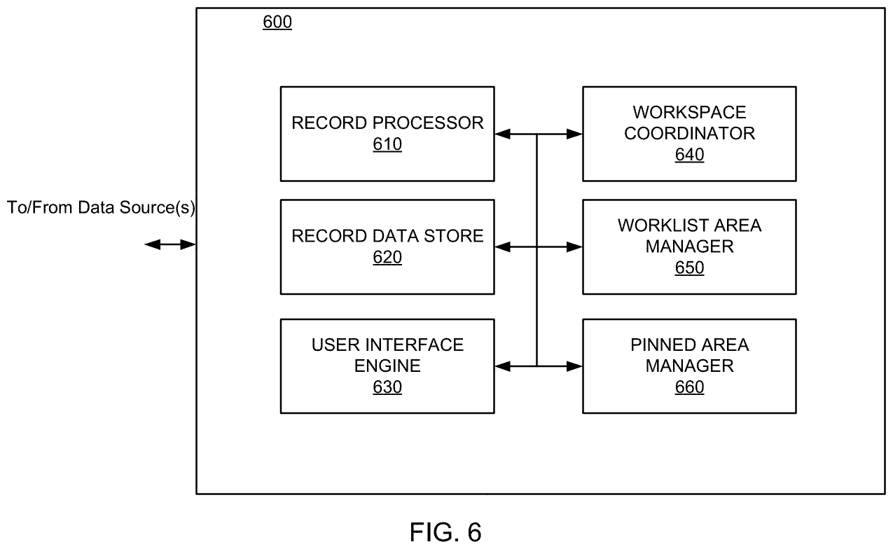

FIG. 6 illustrates an example interface generation and interaction system 600 includes a record processor 610, a record data store 620, a user interface engine 630, a workspace coordinator 640, a worklist area manager 650, and a pinned area manager 660.

The example record processor 610 retrieves and/or receives incoming records such as exam records, other patient records, etc., and processes those records for display and interaction via the example interface 100. For example, the record processor 610 generates tiles, icons, etc., to represent each record so the representations can be displayed for interaction via the worklist area 120, pinned area 110, etc. In certain examples, the record processor 610 receives the representations and/or information regarding the records to generate the representations but does not access the records themselves until a record is requested from the pinned area 100 or worklist area 120 for display in the workspace 130. In certain examples, the record processor 610 can facilitate interaction with records (e.g., patient records, exam records, etc.) via the workspace 130 to retrieve information, update information, add annotations and/or reports, etc. Records, representations of records, flags associated with records (e.g., pinned vs. unpinned, etc.) are stored in the example data store 620, for example.

The example user interface engine 630 drives the user interface display 100, 326 to provide the worklist area 120, pinned area 110, and workspace 130 for interaction. The user interface engine 630 manages and organizes content on the display 100 and coordinates constant display of the pinned area 110 with items flagged in the data store 620 as pinned. The user interface engine 630 coordinates hiding and revealing the worklist area 120 based on user action, settings, loaded application(s), etc., and coordinates display of items in the workspace 130, for example. Thus, the user interface engine 630 provides new technology to enable the pinned area 110 (e.g., a pinned column or bar, etc.) to remain visible and interactive on the interface 100 while the worklist area 120 can disappear and fluctuate depending upon preferences, screen real estate demands, etc. By providing the pinned area 110, important records can be maintained for easy access and reminders, while improving available interface real estate for the workspace 130 and/or other items when the worklist area 120 is hidden, for example.

The example workspace coordinator 640 coordinates interaction with records and/or other information in the workspace 130. For example, the workspace coordinator 640 works with the record processor 610 to display exam and/or other patient records and facilitate interaction with those record(s) via the interface 100. In certain examples, the workspace coordinator 640 displays record(s) and/or other information retrieved from a remote system (e.g., a PACS, enterprise archive, vendor neutral archive, RIS, cloud server, etc.) via the record processor 610, and the record processor 610 facilitates update of the remote and/or local record via the interface 100 and the workspace coordinator 640.

The example worklist area manager 650 manages display of the worklist area 120 via the interface 100 and interaction with the worklist area 120 (e.g., to select an item for display of a corresponding record, to reposition an item in the worklist area 120, to pin or unpin an item in the worklist area 120 for the pinned area 110, etc.). The worklist area manager 650 works with the record processor 610 to determine records to be displayed in the worklist area 120 and records to be retrieved and/or otherwise accessed (e.g., remotely) based on selection of a representation in the worklist area 120. The worklist area manager 650 also works with the pinned area manager 660 and references data structures in the record data store 620 to determine which worklist area 120 items are pinned for the pinned area 110, for example.

The example pinned area manager 660 manages organization and display of the pinned area 110 (e.g., a pinned bar or column, etc.) on the interface 100 as well as interaction with the pinned area 110 (e.g., to select an item from the pinned area 110 for display of a corresponding record, to reposition an item in the pinned area 110, to pin or unpin an item in the pinned area 110, drag an item into or out of the pinned area 110 to pin/unpin the item, etc.). The pinned area 110 references data structures in the data store 620 to set flags, unset flags, display flagged items in the pinned area 110, removed unflagged items from the pinned area 110, etc. The pinned area manager 660 works with the record processor 610 to determine records to be displayed in the pinned area 110 and records to be retrieved and/or otherwise accessed (e.g., remotely) based on selection of a representation in the pinned area 110.

Thus, the example interface 100 can be driven by the interface generation and interaction system 600 to provide a workload manager including the pinned area 110 and worklist area 120 as well as a diagnostic hub or workspace 130. In certain examples, one or more worklist area 120 tabs providing access to various tasks that a radiologist may address during a shift. In some examples, a first category, ‘My Work’, houses various worklists from which a radiologist may choose to work. My Work can be divided into two subcategories: 1) items, potentially from any worklist, that a radiologist has actively reserved, been assigned by others to or begun reading (‘Reserved,’ ‘Assigned’, ‘Saved Drafts’, etc.), and 2) saved worklists that may be collaborative, cross-departmental, rotation-specific, and/or otherwise customized, for example. Other categories include ‘Saved Cases’, for cases that a radiologist wants to reference later, ‘Messages’ for communication and collaboration, ‘My History’ for easy access recently finalized exams, and ‘Protocols’ for scheduled or ordered exams that may involve consultation with a radiologist on proper exam performance, for example. Unread and/or unassigned exams can also be represented in the worklist area 120.

Selection of the worklist area 120 and an item in the worklist area 120 triggers information regarding that item to be displayed in the workspace 130. For example, when a radiologist selects the worklist area 120, exams within the worklist area 120 are displayed in tile/icon format. Each tile includes metadata that can be useful when a radiologist is determining whether or not he/she is responsible for reading an exam (e.g., the metadata includes an indication of responsible/associated radiologist, patient, exam, referring physician, type, facility, etc.). If necessary or desired, a user can expand a width of the worklist to reveal more patient and exam metadata in each tile, for example. Actions can similarly be taken with respect to item tiles/icons in the pinned area 110, for example.

In certain examples, several actions can be taken within and/or with respect to a worklist area 120 and/or pinned area 110 item. For example, a tile can include a status and available action(s) for the user (e.g., reserve, unreserve, assign, unassign, decline, accept, etc.). In some examples, a right click and/or other selection displays indication(s) of activity by other users on that exam (e.g., viewing, actively dictating, adding images, etc.). Stat or urgent cases can be marked with a red banner and/or indicator in the tile/icon, for example. An exam can be selected from the worklist area 120 or pinned area 110 and provided to the workspace 130, for example.

In certain examples, the workspace 130 is a home for all of a patient's exam-related information (e.g., non-image data, etc.). The workspace 130 positions a radiologist and/or other clinician to provide more accurate diagnoses by quickly highlighting relevant comparisons as well as a current patient's broader clinical history. For example, one or more related imaging studies, prior exams, patient history, and/or other clinical documentation can be displayed together with the current exam and/or other clinical scenario under review. In certain examples, file(s) and/or area(s)/portion(s) of files that are relevant can be highlighted for analysis.

### IV. Example Interface Generation and Management Methods

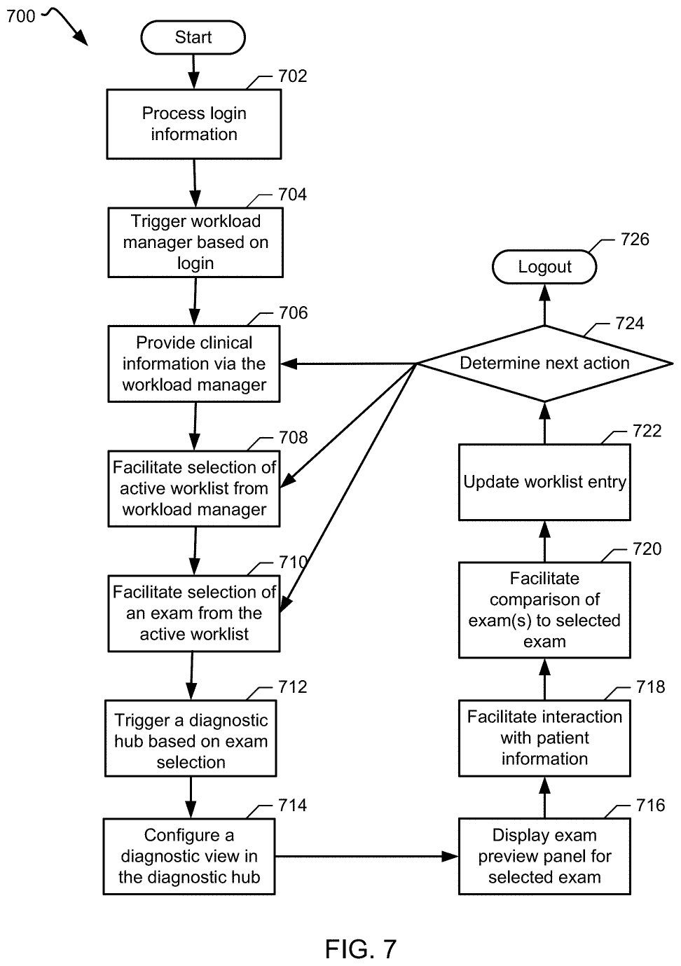

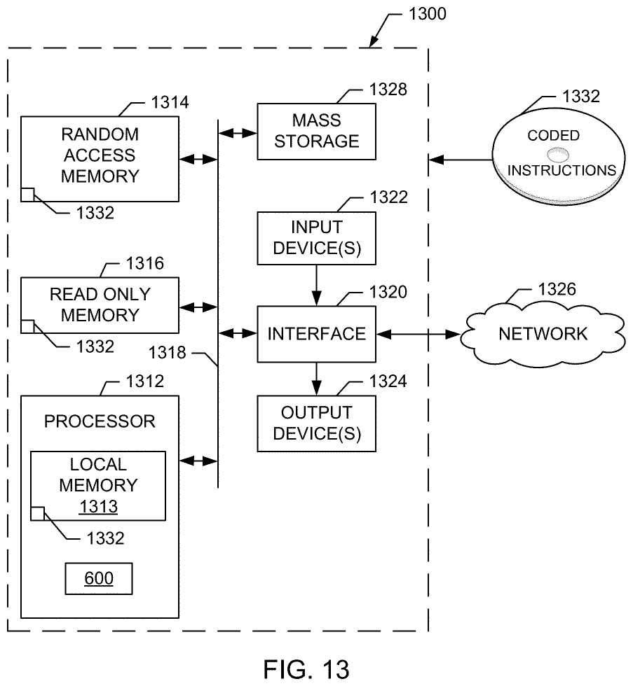

Flowcharts representative of example machine readable instructions for implementing and/or executing in conjunction with the example systems, algorithms, and interfaces of FIGS. 1-6 are shown in FIGS. 7-10C. In these examples, the machine readable instructions comprise a program for execution by a processor such as the processor 1312 shown in the example processor platform 1300 discussed below in connection with FIG. 13. The program can be embodied in software stored on a tangible computer readable storage medium such as a CD-ROM, a floppy disk, a hard drive, a digital versatile disk (DVD), a BLU-RAY™ disk, or a memory associated with the processor 1312, but the entire program and/or parts thereof could alternatively be executed by a device other than the processor 1312 and/or embodied in firmware or dedicated hardware. Further, although the example program is described with reference to the flowcharts and/or processes illustrated in FIGS. 7-10C, many other methods of implementing the examples disclosed and described here can alternatively be used. For example, the order of execution of the blocks can be changed, and/or some of the blocks described can be changed, eliminated, or combined.

As mentioned above, the example processes of FIG. 7-10C can be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7-10C can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 7 illustrates a flow diagram for an example method 700 to integrate a worklist area 120 (and a pinned area 110) with a diagnostic workspace 130 via an interaction framework. At block 702, a login is processed to access the interaction framework. For example, a user provides information for single sign on (SSO) to a system including the interaction framework. At block 704, based on the login, a workload manager (WM) is triggered. The WM is displayed via a graphical user interface 100 on a display screen, for example. The WM includes the pinned area 110 and the worklist area 120, for example. At block 706, information, such as worklist(s) 120, associated pinned area 110, and perhaps a plurality of patients associated with the worklist(s), is provided via the WM.

At block 708, selection of an active worklist area 120 from the WM is facilitated. The active worklist area 120 is displayed via the WM. At block 710, selection of an exam from the active worklist area 120 is facilitated. For example, the active worklist area 120 displays a list of available exams associated with the active worklist, and one of the list of exams is selected. Similarly, the pinned area 110 displays a subset of the list of exams for selection.

At block 712, a diagnostic hub (DH) workspace 130 is triggered based on selection of the exam. At block 714, a diagnostic view is configured in the diagnostic hub workspace 130 for the selected exam according to the worklist area 120/pinned bar 110 and patient information (e.g., stored and/or temporarily maintained in the data store 620). For example, the graphical user interface 100 of the display screen adjusts the configuration such that the DH 130 is displayed adjacent to the WM 110/120 in the graphical user interface 100. A patient banner can be provided in conjunction with the selected exam via the DH diagnostic view. The patient banner provides certain summary, demographic, and/or other identifying information for a patient associated with the selected exam, for example.

At block 716, an exam preview panel is displayed in the DH workspace 130 based on the selected exam and patient. The exam preview panel provides a summary of the selected exam that the radiologist is currently responsible for reading, for example.

At block 718, interaction with patient information is facilitated via the diagnostic view or workspace 130 of the DH. Patient information can be viewed, reviewed, modified, added, deleted, etc., via the DH 130. At block 720, one or more exams can be chosen for comparison to the primary selected exam displayed via the preview panel. For example, a patient library provided via the DH provides relevant comparison exam(s) and/or other clinical content to aid in diagnosis.

At block 722, a patient record and associated exam worklist entry can be updated based on the comparison. Thus, imaging-related clinical context, image review/comparison, and/or other clinical and/or operational insight can be factored into a report and/or other analysis of the exam. The report and/or other analysis can be saved in conjunction with the patient, exam, and/or worklist, for example. The worklist entry and associated record can also be based on selection/deselection for the pinned area 110, for example.

At block 724, after the update, a user can choose to branch to a variety of next actions. For example, control can switch to block 706 with updated clinical information provided via the workload manager. Alternatively or in addition, control can shift to block 708 for selection of another active worklist from the workload manager. As another option, control can shift to block 710 for selection of another exam from the current active worklist. An exam entry in the worklist area 120 can be pinned to and/or unpinned from the pinned area 110, for example. Alternatively, at block 726, logout is facilitated.

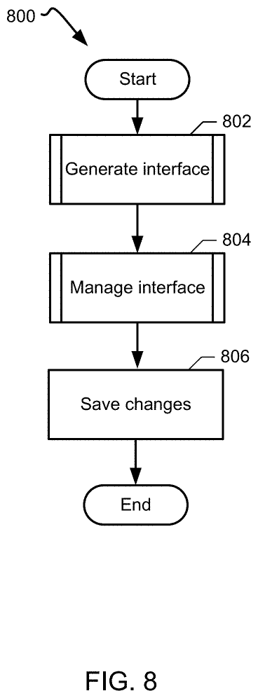

FIG. 8 illustrates a flow diagram for an example method 800 to generate and manage a user interface display. At block 802, a user interface 100 is generated. For example, records are retrieved and/or referenced by indicators, tiles, etc., and organized into the worklist area 120 and pinned area 110 with respect to the workspace 130 on the display 100. At block 804, the interface 100 is managed or maintained. For example, user selection of an item from the pinned area 110 or the worklist area 120 triggers display of corresponding information for interaction via the workspace 130. Selection of an item in the worklist area 120 can pin or unpin the item from the pinned area 110. Movement of an item from the worklist area 120 to the pinned area 110 maintains the item in the worklist area 120 but also adds the item to the pinned area 110 and flags its corresponding record in the data structure of the data store 620 as pinned. Movement of an item from the pinned area 110 to the worklist area 120 maintains the item in the worklist area 120 but removes the item from the pinned area 110 and removes the flag associated with its corresponding record in the data structure of the data store 620 so that the item is no longer pinned, for example. At block 806, changes made to the interface (e.g., pinned and/or unpinned items, reordering of items in the pinned area 110, etc.) are saved for recall in later sessions/use. Thus, an updated configuration of the interface 100 can be saved in the data store 620 to enable configuration of the interface 100 upon next launch, etc., for example.

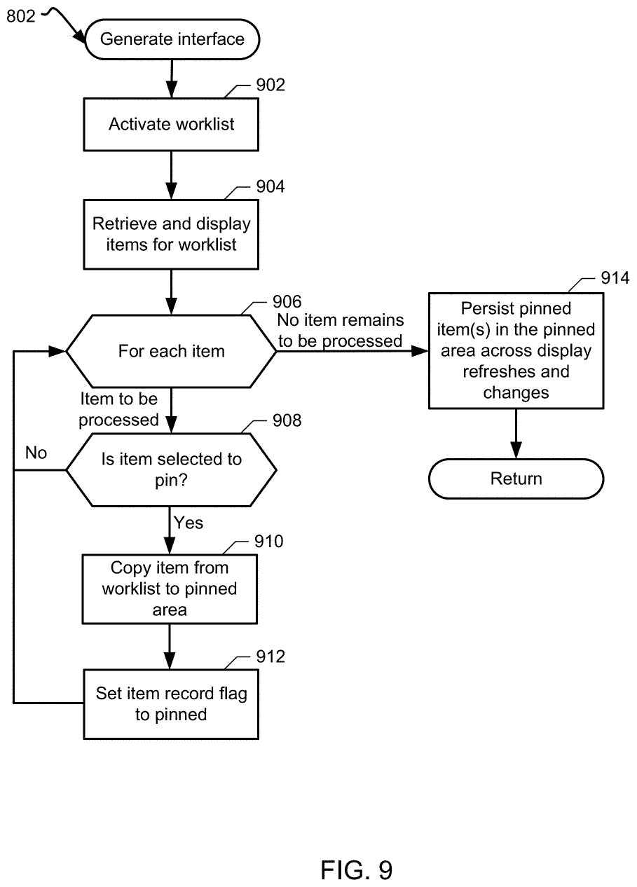

FIG. 9 illustrates a flow diagram providing further detail regarding an example implementation of generating the user interface 100 (block 802). At block 902, the worklist area 120 is activated. For example, the user interface engine 630 activates the worklist area manager 650, the pinned area manager 660, and the workspace coordinator 640 to configure the user interface 100. At block 904, items for the worklist area 120 are retrieved and displayed. For example, items (e.g., tiles, icons, etc.) corresponding to records for a user, patient, department, workflow, etc., are processed by the record processor 610 and used to populate the worklist area 120.

At block 906, each item in the worklist area 120 is processed. At block 908, the item is reviewed to determine whether the item is pinned. For example, a record in the data store 620 associated with the item, selection/movement of the item on the interface 100, etc., is analyzed to determine whether the record is flagged or is to be flagged as pinned. If the item is selected to pin, then, at block 910, the item is copied from the worklist area 120 to the pinned area 110 and/or otherwise duplicated on the pinned area 110. At block 912, a record in the data store 620 is flagged to indicate that the item is pinned.

The process repeats to determine whether each item in the worklist area 120 is flagged or is to be flagged. When no items remain to be processed, at block 914, pinned items persist in the pinned area 110 of the interface 100 across display refreshes and other changes until the item is unpinned. Control then returns to block 804.

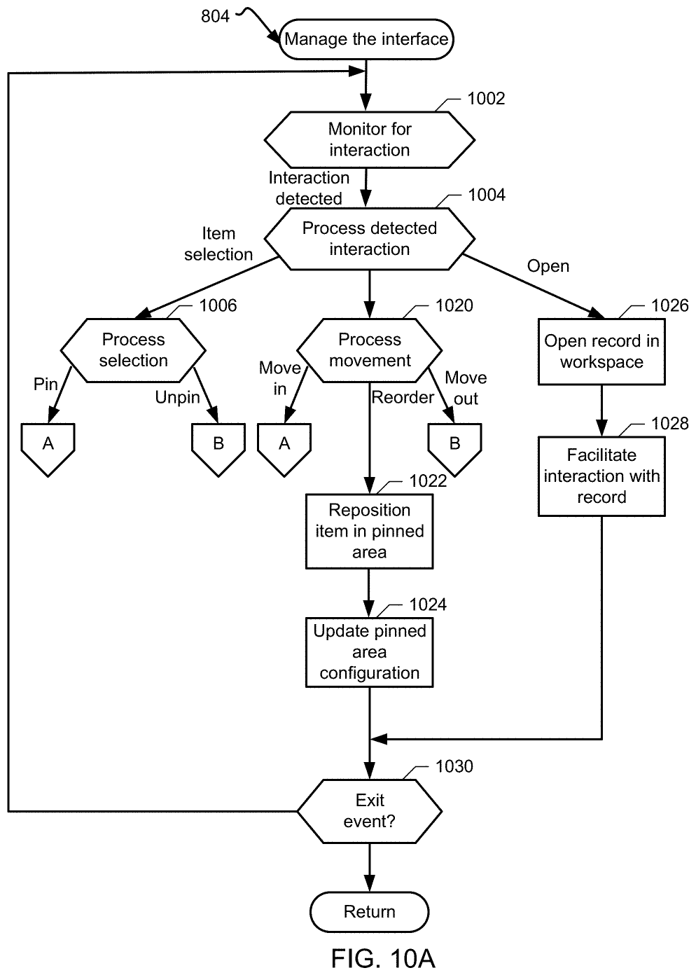

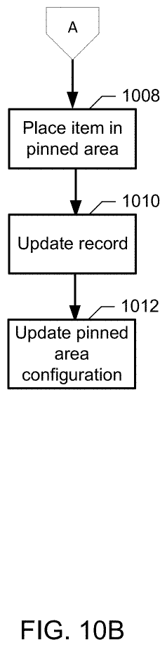

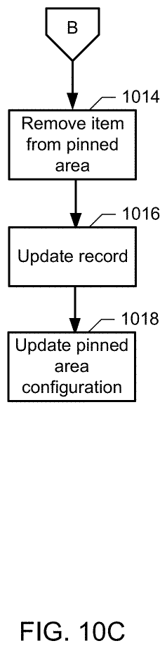

FIGS. 10A-C illustrates a flow diagram providing further detail regarding an example implementation of managing the user interface 100 (block 804). At block 1002, the user interface 100 is monitored for interaction. For example, the record processor 610, user interface engine 630, workspace coordinator 640, worklist area manager 650, and/or pinned area manager 660 monitor for updated information to the data store 620, user interaction with the interface 100, etc. At block 1004, detected interaction is processed.

For example, interaction can be selection of an item and/or other indicator associated with the item. If so, at block 1006, the selection is processed to determine if the selection is a pinning or unpinning of the corresponding item.

If the selection is to pin the item, then, at block 1008, a copy of the item is placed in the pinned area 110, and, at block 1010, a record associated with the item is updated to flag the item as pinned. At block 1012, a configuration of the pinned area 110 is updated to reflect the presence of the item in the pinned area 110. The sequence of blocks 1008-1012 is referred to herein as “A” for ease of reference in the flow diagrams.

If the selection is to unpin the item, then, at block 1014, the item is removed from the pinned area 110, and, at block 1016, a record associated with the item is updated to unflag the item. At block 1018, the configuration of the pinned area 110 is updated to reflect the removal of the item from the pinned area 110. The sequence of blocks 1014-1018 is referred to herein as “B” for ease of reference in the flow diagrams.

If the interaction is movement of an item, then, at block 1020, the movement is processed to determine if the movement is to move an item into the pinned area 110, remove an item from the pinned area 110, or reorder an item within the pinned area 110. If the movement is to move the item into the pinned area 110, then, at block 1008, a copy of the item is placed in the pinned area 110, and, at block 1010, a record associated with the item is updated to flag the item as pinned. At block 1012, a configuration of the pinned area 110 is updated to reflect the presence of the item.

If the movement is to remove the item from the pinned area 110, then, at block 1014, the item is removed from the pinned area 110, and, at block 1016, a record associated with the item is updated to unflag the item. At block 1018, the configuration of the pinned area 110 is updated to reflect the removal of the item.

If the movement is to reorder the item in the pinned area 110, then, at block 1022, the item is repositioned in the pinned area 110. At block 1024, the configuration of the pinned area 110 is updated to reflect the reordering of items.

If the interaction is to open an item, then, at block 1026, a record and/or other information associated with the item is opened in the workspace 130. The content is then made available for review and interaction (block 1028) in the workspace 130 via the record processor 610, data store 620, user interface engine 630, and workspace coordinator 640.

At block 1030, interaction continues to be monitored to update the interface 100 and associated information until an exit event is detected (e.g., to logout, close the interface 100, etc.). Upon detection of an exit event, control reverts to block 860.

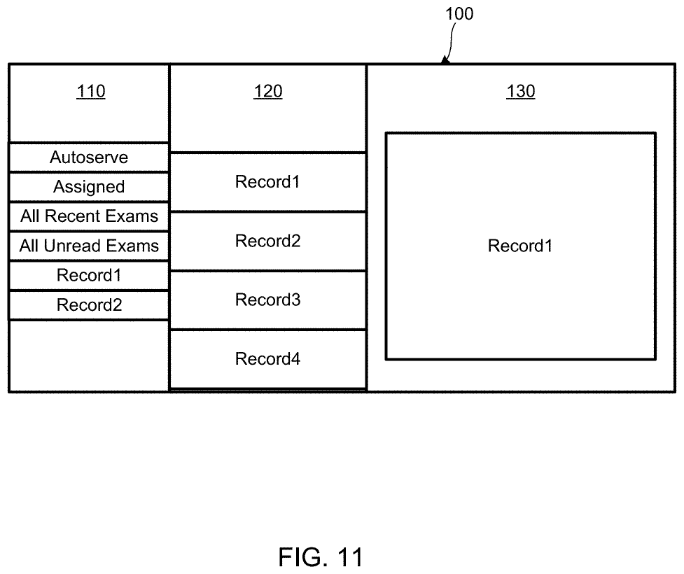

FIG. 11 illustrates an example implementation of the user interface 100 including the pinned area 110, worklist area 120, and workspace 130. As shown the example of FIG. 11, a worklist area 120 of exams (Record1, Record2, Record3, Record4, etc.) is provided via the interface 100, and a subset of those exams is also found in the pinned bar 110 (e.g., Record1, Record2 in shortened form, etc.). The pinned bar area 110 also includes shortcuts for Autoserving of exam assignments, exam(s) assigned to the user, recent exams, unread exams, etc. In the example of FIG. 11, Record1 has been selected and is displayed in the workspace 130.

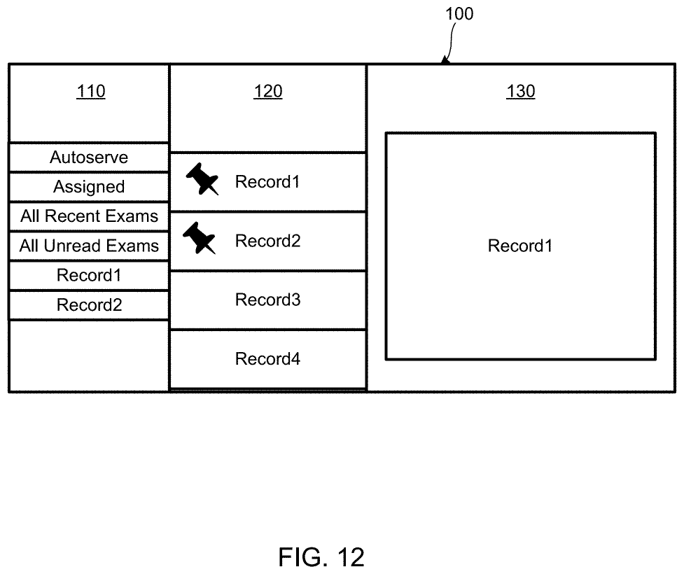

FIG. 12 shows another example implementation of the user interface 100. In the example of FIG. 12, Record1 and Record2 in the worklist are pinned 1202, 1204, triggering placement of Record1 and Record2 in the pinned area 110 and an update of the corresponding data structures in the data store 620.

### V. Computing Device

The subject matter of this description may be implemented as stand-alone system or for execution as an application capable of execution by one or more computing devices. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input/instructions, generating graphic illustrations) with users via the computing device(s).

Memory and processor as referred to herein can be stand-alone or integrally constructed as part of various programmable devices, including for example a desktop computer or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like or as part of a Computing Device, and any combination thereof operable to execute the instructions associated with implementing the method of the subject matter described herein.

Computing device as referenced herein can include: a mobile telephone; a computer such as a desktop or laptop type; a Personal Digital Assistant (PDA) or mobile phone; a notebook, tablet or other mobile computing device; or the like and any combination thereof.

Computer readable storage medium or computer program product as referenced herein is tangible (and alternatively as non-transitory, defined above) and can include volatile and non-volatile, removable and non-removable media for storage of electronic-formatted information such as computer readable program instructions or modules of instructions, data, etc. that may be stand-alone or as part of a computing device. Examples of computer readable storage medium or computer program products can include, but are not limited to, RAM, ROM, EEPROM, Flash memory, CD-ROM, DVD-ROM or other optical storage, magnetic cassettes, magnetic tape, magnetic disk storage or other magnetic storage devices, or any other medium which can be used to store the desired electronic format of information and which can be accessed by the processor or at least a portion of the computing device.

The terms module and component as referenced herein generally represent program code or instructions that causes specified tasks when executed on a processor. The program code can be stored in one or more computer readable mediums.

Network as referenced herein can include, but is not limited to, a wide area network (WAN); a local area network (LAN); the Internet; wired or wireless (e.g., optical, Bluetooth, radio frequency (RF)) network; a cloud-based computing infrastructure of computers, routers, servers, gateways, etc.; or any combination thereof associated therewith that allows the system or portion thereof to communicate with one or more computing devices.

The term user and/or the plural form of this term is used to generally refer to those persons capable of accessing, using, or benefiting from the present disclosure.

FIG. 13 is a block diagram of an example processor platform 1300 capable of executing instructions to implement the example systems and methods disclosed and described herein. The processor platform 1300 can be, for example, a server, a personal computer, a mobile device (e.g., a cell phone, a smart phone, a tablet such as an IPAD™), a personal digital assistant (PDA), an Internet appliance, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 can be implemented by flash memory and/or any other desired type of memory device. Access to the main memory 1314, 1316 is controlled by a memory controller.

The processor platform 1300 of the illustrated example also includes an interface circuit 1320. The interface circuit 1320 can be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

The coded instructions 1332 can be stored in the mass storage device 1328, in the volatile memory 1314, in the non-volatile memory 1316, and/or on a removable tangible computer readable storage medium such as a CD or DVD. The instructions 1332 can be executed by the processor 1312 to implement the example interface system 600, etc., as disclosed and described above.

From the foregoing, it will be appreciated that example methods, apparatus and articles of manufacture have been disclosed that improve user interface display and interaction. The disclosed methods, apparatus and articles of manufacture improve the efficiency of using a computing device and an interface being driven by the computing device by providing a pinned area in addition to a worklist to display, hide, persist, and open records for interaction in a workspace of the interface. Certain examples improve a computer system and its process and user interface display through the ability to monitor events including interaction with interface content and persist some items via a pinned area while allowing a larger, more comprehensive list of items to be hidden and revealed depending on interaction, configuration, screen real estate demands, etc. Certain examples alter the operation of the computing device and provide a new data structure to store interface configuration information including flagged records for the pinned area and other ordering and configuration information. The disclosed methods, apparatus and articles of manufacture are accordingly directed to one or more improvement(s) in the functioning of a computer.

Certain examples provide a pinned bar apparatus and associated methods to drive a section of the user interface to hold a portion of a worklist that is deemed important enough to make visible at all time during operation of the application. Items in a worklist are given a “pinned” attribute that can be set from the interface and persists in the data store and associated data structure(s). When worklist(s) are loaded, those item(s) with the pinned attribute are added to the pinned bar. Additionally, if an order preference has been persisted, the pinned item(s) are ordered accordingly. Otherwise, items appear in alphabetical order and/or order of urgency, for example. A user can change the order of the pinned items by dragging and dropping them. This information is persisted to the database to be used the next time the user logs in. If the user drags the pinned worklist off the pinned bar, the item is removed from the pinned bar. A global and/or group worklist can include pinned items and an order set at an administrator level, for example, which can be merged with user level preference, for example. The items can be individual items, worklists, subsections of a worklist, etc.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A graphical user interface system to display clinical data and a clinical worklist, the system comprising:
a memory to store instructions, data, and configuration information; and
a processor to execute the instructions to generate a user interface including:
a worklist area to display indicators associated with items to be opened for review, the items selectable to be opened or moved, the worklist area to be hidden or displayed based on a configuration of the user interface; and
a pinned area to display a copy of a selected subset of the items in the worklist area, the pinned area to remain visible when the worklist area is hidden and to persist across sessions of the user interface, wherein a data structure associated with the subset of the items is to be flagged.

2. The system of claim 1, wherein the processor is to further execute the instructions to generate the user interface including a workspace to open and interact with a record associated with an item in at least one of the worklist area or the pinned area.

3. The system of claim 1, wherein a first item in the selected subset of the items is to be selected by selecting a first indicator associated with the first item in the worklist area, and wherein selecting the first indicator is to trigger the processor to leave the first indicator in the worklist area and create a copy of the first indicator to be displayed in the pinned area.

4. The system of claim 3, wherein selecting the first indicator triggers the processor to display a pinned icon in the worklist area adjacent the first indicator for the first item.

5. The system of claim 4, wherein selecting the pinned icon is to trigger the processor to remove the copy of the first indicator from the pinned area, remove the pinned icon adjacent the first indicator in the worklist area, and unflag a data structure associated with the first item.

6. The system of claim 1, wherein a first item in the selected subset of the items is to be selected by moving a first indicator associated with the first item from the worklist area to the pinned area, and wherein the moving of the first indicator is to trigger the processor to leave the first indicator in the worklist area and create a copy of the first indicator to be displayed in the pinned area.

7. The system of claim 6, wherein moving the copy of the first indicator out of the pinned area is to trigger the processor to remove the copy of the first indicator from the pinned area and unflag a data structure associated with the first item.

8. A computer-readable storage medium including instructions which, when executed, cause at least one processor to generate a user interface including at least:
a worklist area to display indicators associated with items to be opened for review, the items selectable to be opened or moved, the worklist area to be hidden or displayed based on a configuration of the user interface; and
a pinned area to display a copy of a selected subset of the items in the worklist area, the pinned area to remain visible when the worklist area is hidden and to persist across sessions of the user interface, wherein a data structure associated with the subset of the items is to be flagged.

9. The computer-readable storage medium of claim 8, wherein the instructions, when executed, further cause the processor to generate the user interface including a workspace to open and interact with a record associated with an item in at least one of the worklist area or the pinned area.

10. The computer-readable storage medium of claim 8, wherein a first item in the selected subset of the items is to be selected by selecting a first indicator associated with the first item in the worklist area, and wherein selecting the first indicator is to trigger the processor to leave the first indicator in the worklist area and create a copy of the first indicator to be displayed in the pinned area.

11. The computer-readable storage medium of claim 10, wherein selecting the first indicator triggers the processor to display a pinned icon in the worklist area adjacent the first indicator for the first item.

12. The computer-readable storage medium of claim 11, wherein selecting the pinned icon is to trigger the processor to remove the copy of the first indicator from the pinned area, remove the pinned icon adjacent the first indicator in the worklist area, and unflag a data structure associated with the first item.

13. The computer-readable storage medium of claim 8, wherein a first item in the selected subset of the items is to be selected by moving a first indicator associated with the first item from the worklist area to the pinned area, and wherein the moving of the first indicator is to trigger the processor to leave the first indicator in the worklist area and create a copy of the first indicator to be displayed in the pinned area.

14. The computer-readable storage medium of claim 13, wherein moving the copy of the first indicator out of the pinned area is to trigger the processor to remove the copy of the first indicator from the pinned area and unflag a data structure associated with the first item.

15. A computer-implemented method comprising:
displaying, in a worklist area of a user interface, indicators associated with items to be opened for review, the items including a first item selectable to be opened and moved;
displaying, in response to selecting a first indicator associated with the first item in the worklist area, a copy of the first item in a pinned area of the user interface;
flagging, in response to selecting the first indicator in the worklist area, a data structure associated with the first item;
hiding, in response to at least one of an interaction or a user interface configuration, the worklist area on the user interface; and
persisting display of the pinned area when the worklist area is hidden.

16. The method of claim 15, wherein selecting the first indicator includes selecting the first indicator to trigger the processor to leave the first indicator in the worklist area and create a copy of the first indicator to be displayed in the pinned area.

17. The method of claim 16, wherein selecting the first indicator further includes displaying a pinned icon in the worklist area adjacent the first indicator for the first item.

18. The method of claim 16, wherein selecting the pinned icon is to trigger removing the copy of the first indicator from the pinned area, removing the pinned icon adjacent the first indicator in the worklist area, and unflagging the data structure associated with the first item.

19. The method of claim 15, wherein selecting the first indicator includes moving the first indicator from the worklist area to the pinned area, and wherein the moving of the first indicator is to leave the first indicator in the worklist area and create a copy of the first indicator to be displayed in the pinned area.

20. The method of claim 19, further including, removing, in response to moving the copy of the first indicator out of the pinned area, the copy of the first indicator from the pinned area and unflagging the data structure associated with the first item.
